(19) United States
(12) Patent Application Publication
(10) Pub. No.: US 2016/0365744 A1
(43) Pub. Date: Dec. 15, 2016

(54) WIRELESS CHARGING DEVICE FOR VEHICLE

(71) Applicant: SAMSUNG ELECTRO-MECHANICS CO., LTD., Suwon-si (KR)

(72) Inventor: Ji Ho HYUN, Suwon-si (KR)

(73) Assignee: SAMSUNG ELECTRO-MECHANICS CO., LTD., Suwon-si (KR)

(21) Appl. No.: 15/017,702

(22) Filed: Feb. 8, 2016

(30) Foreign Application Priority Data
Jun. 12, 2015 (KR) 10-2015-0083469
Sep. 1, 2015 (KR) 10-2015-0123826

(51) Int. Cl. H02J 7/02; H04B 1/3877; H02J 7/04; H04B 5/00

(52) U.S. Cl. CPC H02J 7/025; H04B 5/0037; H04B 1/3877; H02J 7/04

(57) ABSTRACT

The wireless charging device for a vehicle includes a support disposed on one side of a cover and configured to support a power receiving device to receive power transmitted from a wireless charging module. The support is coupled to the cover and is configured to adjust to dimensions of the power receiving device.

### CROSS-REFERENCE TO RELATED APPLICATIONS

This application claims the benefit under 35 USC 119(a) of Korean Patent Application Nos. 10-2015-0083469 filed on Jun. 12, 2015 and 10-201 5-01 23826 filed on Sep. 1, 2015, with the Korean Intellectual Property Office, the entire disclosures of which are incorporated herein by reference for all purposes.

### BACKGROUND

1. Field

The following description relates to a wireless charging device for a vehicle, in which a portable terminal is stably mounted.

2. Description of Related Art

In general, most wireless communications devices need to be charged. Recently, portable devices have been developed that are charged using different types of wired connectors.

When a battery is provided for charging in a portable terminal with electrical energy, methods for charging the battery may include: providing a terminal connection for receiving commercially-available alternating current (AC) power, converting the AC power into a current having a voltage appropriate to charge a battery, and supplying electrical energy through a terminal of the corresponding battery. Additionally or alternatively, wireless charging may be provided for overcoming inconveniences of wired charging in the terminal connection method.

A method of wireless charging using magnetic resonance and magnetic induction method has been developed. Non-contact wireless charging technology using the magnetic induction method has increased in popularity.

In the case of using a wireless charging device in a vehicle, a portable terminal may be separated from a holder due to a shock or shaking during driving. Accordingly, there is a need for a device to more stably hold a portable terminal to wirelessly charge the portable terminal.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect, a wireless charging device may include a cover rotatably coupled to an interior member of the vehicle and includes a wireless charging module formed therein, and a support disposed on one side of a cover and configured to support a power receiving device, the power receiving device to receive power transmitted from a wireless charging module. The support is coupled to the cover and is configured to adjust to dimensions of the power receiving device.

The support may include first and second supports spaced apart and facing each other and a third support configured to move perpendicularly to a moving direction of the first and second supports.

The cover may include an external cover, and an internal cover coupled to one surface of the external cover. The support is disposed at least partially between the external cover and the internal cover.

The support may include an insertion portion disposed between the external cover and the internal cove, an extension portion extending away from the insertion portion, and a protrusion portion protruding from the extension portion toward a center of the cover.

The wireless charging device may include a rotating engagement member disposed between the external cover and the internal cover. The rotating engagement member may include a first sawtooth portion disposed on an outer circumferential surface of the engagement member.

The insertion portion may include a second sawtooth portion configured to engage with the first sawtooth portion.

The insertion portion and the engagement member may be coupled to each other to form a rack & pinion gear.

The wireless charging device may include an elastic coupler having a first end coupled to the insertion portion and a second end coupled to one surface of the external cover to elastically couple the insertion portion and the external cover.

The elastic coupler may include a coil spring.

The protrusion portion may include a buffer member disposed on an internal surface of the protrusion portion, facing the cover.

The wireless charging module may include a coil portion including a coil, and a circuit portion electrically connected to the coil portion and configured to control power supplied to the coil portion.

The coil portion and the circuit may each be plate-shaped and disposed on the external cover overlapping each other.

The support may include a plurality of supports that are each spaced apart from each other and configured to each move toward a center of one surface of the cover.

The cover may be rotatably coupled to an interior member of the vehicle and may include a wireless charging module.

The support may be configured to hold a center axis of the power receiving device against a center axis of the wireless charging module.

According to another general aspect, a wireless charging device includes a cover configured to open and close an opening of an accommodation space, a support configured to accommodate a power receiving device disposed on one side of the cover, and a wireless charging module configured to wirelessly transmit power to the power receiving device disposed in the cover.

The wireless charging module may include a coil portion including a coil and a circuit portion electrically connected to the coil portion and configured to control power supplied to the coil portion.

In accordance with an embodiment, there is provided a wireless charging device, including: a support disposed on one side of a cover and configured to support a power receiving device to receive power transmitted from a wireless charging module, wherein the support is coupled to the cover and is configured to adjust to dimensions of the power receiving device.

Other features and aspects will be apparent from the following detailed description, the drawings, and the claims.

### BRIEF DESCRIPTION OF DRAWINGS

FIG. 1 is a schematic perspective view illustrating a vehicle wireless charging device, according to an embodiment.

FIG. 2 is a perspective view of the vehicle wireless charging device illustrated in FIG. 1 with a closed cover.

FIGS. 3 and 4 are schematic perspective views of a cover of the vehicle wireless charging device illustrated in FIG. 1.

FIG. 5 is a plan view of the vehicle wireless charging device illustrated in FIG. 3.

FIG. 6 is an exploded perspective view of the vehicle wireless charging device illustrated in FIG. 3.

FIG. 7 is a schematic perspective view of a wireless charging module according to an embodiment.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

Throughout the specification, it will be understood that when an element, such as a layer, region or wafer (substrate), is referred to as being “on,” “connected to,” or “coupled to” another element, it can be directly “on,” “connected to,” or “coupled to” the other element or other elements intervening therebetween may be present. In contrast, when an element is referred to as being “directly on,” “directly connected to,” or “directly coupled to” another element, there may be no elements or layers intervening therebetween. Like numerals refer to like elements throughout. As used herein, the term “and/or” includes any and all combinations of one or more of the associated listed items.

It will be apparent that though the terms first, second, third, etc. may be used herein to describe various members, components, regions, layers and/or sections, these members, components, regions, layers and/or sections should not be limited by these terms. These terms are only used to distinguish one member, component, region, layer or section from another region, layer or section. Thus, a first member, component, region, layer or section discussed below could be termed a second member, component, region, layer or section without departing from the teachings of the exemplary embodiments.

Spatially relative terms, such as “above,” “upper,” “below,” and “lower” and the like, may be used herein for ease of description to describe one element's relationship to another element(s) as shown in the figures. It will be understood that the spatially relative terms are intended to encompass different orientations of the device in use or operation in addition to the orientation depicted in the figures. For example, if the device in the figures is turned over, elements described as “above,” or “upper” other elements would then be oriented “below,” or “lower” the other elements or features. Thus, the term “above” can encompass both the above and below orientations depending on a particular direction of the figures. The device may be otherwise oriented (rotated 90 degrees or at other orientations) and the spatially relative descriptors used herein may be interpreted accordingly.

The terminology used herein is for describing particular embodiments only and is not intended to be limiting of the described embodiments. As used herein, the singular forms “a,” “an,” and “the” are intended to include the plural forms as well, unless the context clearly indicates otherwise. It will be further understood that the terms “comprises,” and/or “comprising” when used in this specification, specify the presence of stated features, integers, steps, operations, members, elements, and/or groups thereof, but do not preclude the presence or addition of one or more other features, integers, steps, operations, members, elements, and/or groups thereof.

Hereinafter, embodiments will be described with reference to schematic views illustrating embodiments of the present inventive concept. In the drawings, for example, due to manufacturing techniques and/or tolerances, modifications of the shape shown may be estimated. Thus, embodiments should not be construed as being limited to the particular shapes of regions shown herein, for example, to include a change in shape results in manufacturing. The following embodiments may also include one or a combination thereof.

The contents of the embodiments described below may have a variety of configurations and propose only a required configuration herein, but are not limited thereto.

A power receiving device, according to embodiments, may include a portable terminal and may be a collective term for various portable electronic devices, such as smartphones, mobile phones, personal digital assistants (PDA), MP3 players, tablet personal computers (PC), portable multimedia players (PMP), etc.

Although the case in which a wireless charging device for a vehicle is positioned below a center fascia of a vehicle is illustrated, exemplary embodiments are not limited thereto. For example, a cup holder type device for wirelessly charging a power receiving device may be formed in various positions in other center consoles, armrests, and so on.

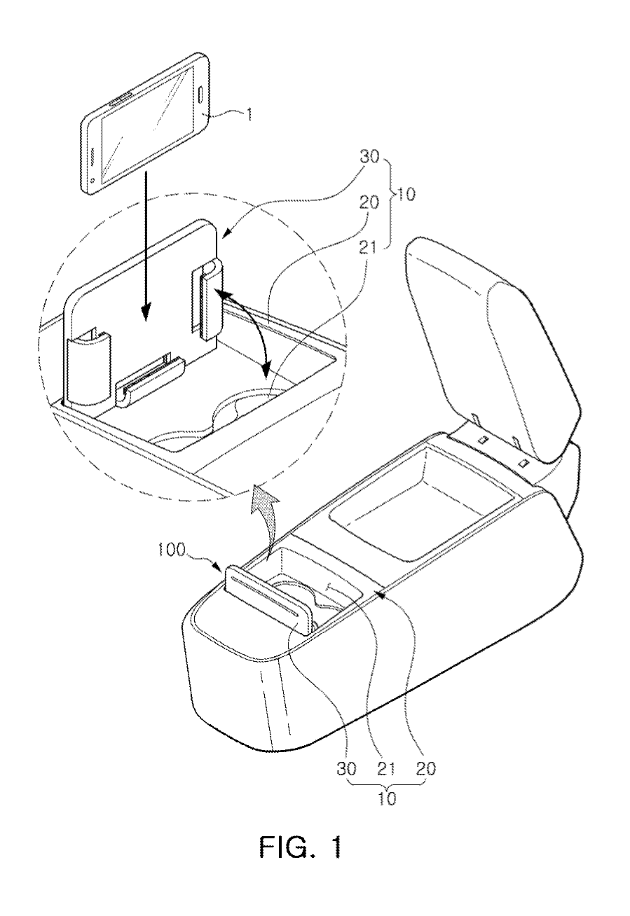

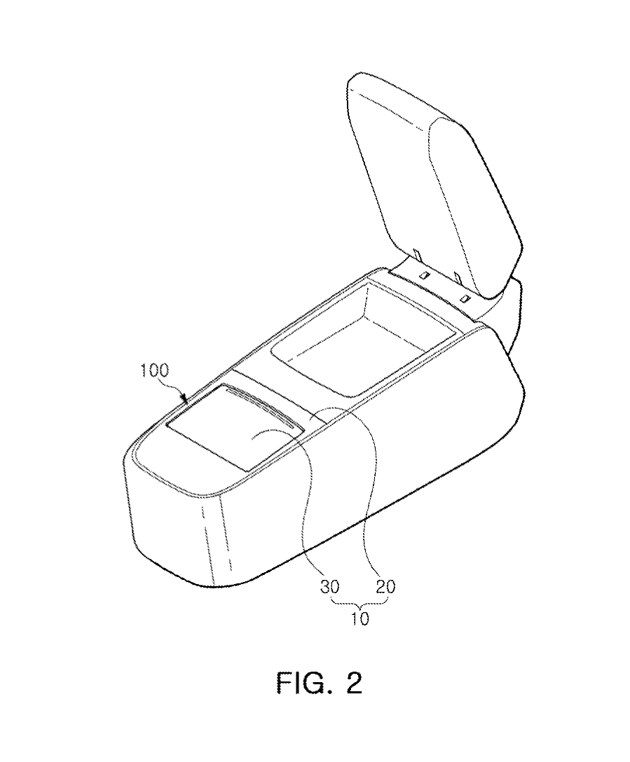

FIG. 1 is a schematic perspective view illustrating a vehicle wireless charging device 100 with an opened cover, according to an embodiment. FIG. 2 is a perspective view of the vehicle wireless charging device 100 with a closed cover.

Referring to FIGS. 1 and 2, the vehicle wireless charging device 100 may be disposed as a portion of an accommodation unit 10.

The accommodation unit 10 is installed on or in an internal member of the vehicle. Here, an internal vehicle member may be various structures such as a center fascia, a center console, or an armrest of the vehicle, but is not limited thereto.

The accommodation unit 10 includes an accommodation space 21 for accommodation of an object. For example, the accommodation unit 10, according to the embodiment is a cup holder unit for accommodating a cup.

The accommodation unit 10 includes an accommodation unit base portion 20 and a cover portion 30. As shown in FIGS. 1 and 2, the vehicle wireless charging device 100 includes cover portion 30 of the accommodation unit 10. Thus, as a non-exclusive example, the cover portion 30 of the accommodation unit 10 is the vehicle wireless charging device 100.

The accommodation unit 10 is disposed on or in an internal vehicle member. The internal vehicle member may be various structures such as a center fascia, a center console, or an armrest of the vehicle, but is not limited thereto.

The accommodation unit base portion 20 includes the accommodation space 21 for accommodation of an object such as a cup.

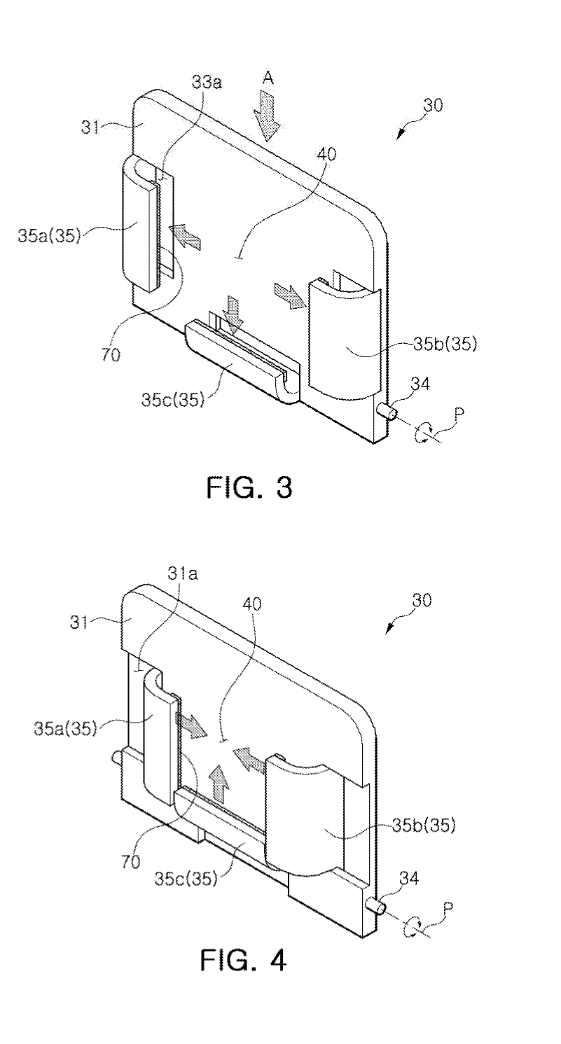

The cover portion 30 is coupled to the accommodation unit base portion 20 at an opening portion of the accommodation space 21. The cover portion 30 is coupled to the accommodation unit base portion 20, and may open and close the opening of the accommodation space 21. For example, the cover portion 30 may be coupled to the accommodation unit base portion 20 to be rotated by a hinge joint. In this case, the cover portion 30 is rotated using a hinge 34 (referring to FIG. 3) as a rotation axis P to open and close the opening of the accommodation space 21.

The cover portion 30 may be configured to be opened and closed via manual manipulation, without being limited thereto. For example, the cover portion 30 may be configured to be automatically opened and closed using a driving unit such as a motor.

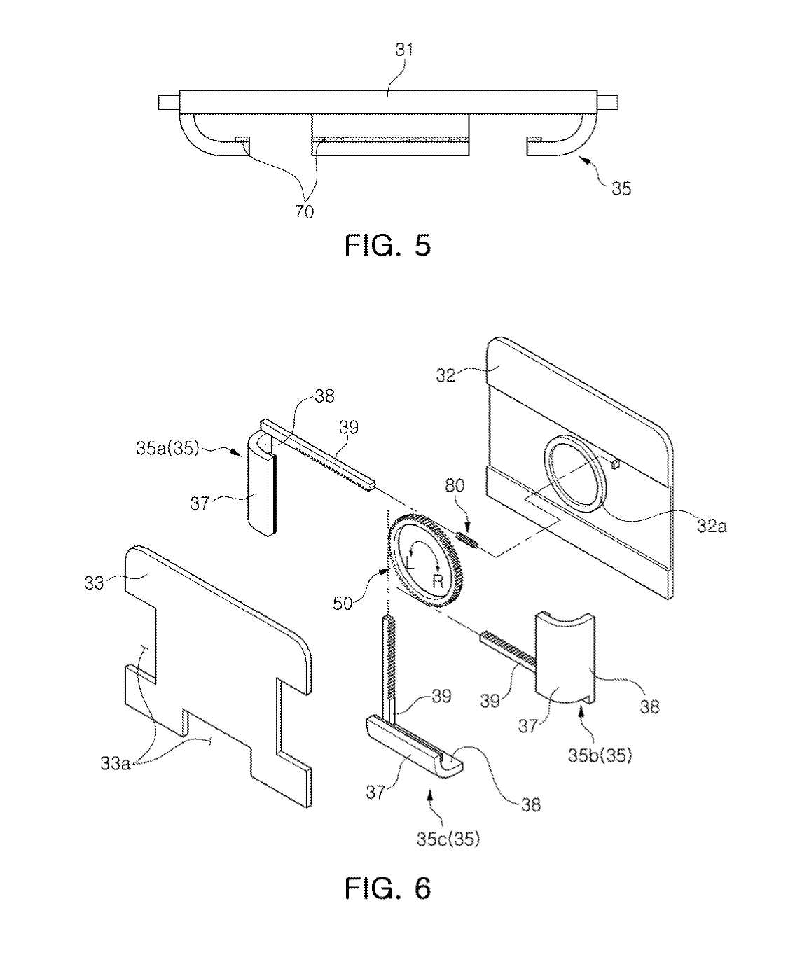

FIGS. 3 and 4 are schematic perspective views of a cover of the vehicle wireless charging device 100 illustrated in FIG. 1. FIG. 5 is a plan view of the vehicle wireless charging device 100 illustrated in FIG. 3. FIG. 6 is an exploded perspective view of the vehicle wireless charging device 100 illustrated in FIG. 3.

Referring to FIGS. 3 through 6, the cover portion 30 includes a cover 31, including an external cover 32 and an internal cover 33, and a support 35.

When the cover portion 30 disposed on the accommodation unit base portion 20 is closed, one surface of the external cover 32 of the cover 31 is externally exposed (as shown in FIG. 2). Accordingly, the external cover 32 is a plate disposed as an outermost portion of the cover portion 30.

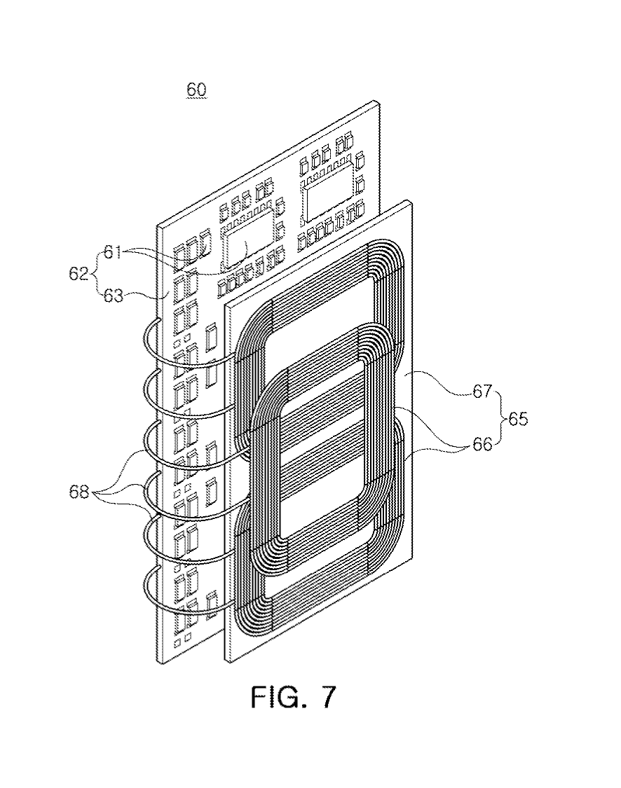

The external cover 32 includes a wireless charging module 60 (refer to FIG. 7) disposed therein. The wireless charging module 60 may wirelessly transmit energy to charge a battery of a portable terminal 1.

The wireless charging module 60 is embedded in the external cover 32. For example, the wireless charging module 60 is completely embedded in the external cover 32 so as not to be visible to the naked eye. However, embodiments are not limited thereto. For example, the wireless charging module 60 may be partially exposed.

FIG. 7 is a schematic perspective view of the wireless charging module 60. Referring to FIG. 7, the wireless charging module 60 is formed with a coil portion 65 including at least one coil 66 and a circuit portion 62 for supplying current to the coil portion 65.

The coil portion 65 may form a magnetic field to radiate wireless power, and may be controlled by the circuit portion 62. To this end, the coil portion 65 is configured by attaching one or more coils 66 on a substrate 67. Here, the coils 66 may be wire-type coils, without being limited thereto, and various modifications may be made. For example, the coils 66 may be formed into conductive pattern on a substrate or may use coils including rectangular copper wire.

The circuit portion 62 is formed by installing a plurality of electronic devices 61 on a circuit substrate 63 and may include a circuit for controlling charging. Accordingly, the coil portion 65 may radiate and transmit power to a portable terminal according to control of the circuit portion 62.

The circuit portion 62 is electrically connected to the coil portion 65 through a connection portion 68. The connection portion 68 may include, for example, a wired type conductive line or a flexible substrate.

The wireless charging module 60 is configured in such a manner such that the circuit portion 62 and the coil portion 65 each have the form of a thin plate and are embedded in the external cover 32. In this manner, circuit portion 62 and coil portion 65 are stacked and overlap each other. In this case, the wireless charging module 60 may be embedded in the external cover 32 to dispose the coils 66 of the coil portion 65 at a side of an internal surface of the external cover 32, that is, at a side of an insertion space 40.

Accordingly, an overall area of the wireless charging module 60 corresponds to an area of the circuit portion 62 and/or the coil portion 65, and a thickness of the wireless charging module 60 may be a combined thickness of the circuit portion 62 and the coil portion 65.

When the circuit portion 62 and the coil portion 65 are embedded in the external cover 32 overlapping each other, the wireless charging module 60 may be disposed in the external cover 32 without enlarging the area of a conventional cup holder unit cover.

In a comparative example, due to the thickness of the wireless charging module 60, the thickness of the external cover 32 may be increased. However, according to present disclosure, the thickness of the external cover 32 may be reduced by minimizing the thickness of the wireless charging module 60. For example, the thickness of the wireless charging module 60 may be minimized by forming the coil portion 65 as a thin film coil.

The internal cover 33 is coupled to an internal surface of the external cover 32. As illustrated in FIG. 6, a portion of the support 35 is inserted between the internal cover 33 and the external cover 32.

To this end, a space for disposing an insertion portion 39 of the support 35 is disposed between the internal cover 33, the external cover 32, and an engagement member 50. In this configuration, the engagement member 50 operatively connects the supports 35, and is inserted between the internal cover 33 and the external cover 32.

The engagement member 50 is a gear that includes a through hole formed therein and a sawtooth formed on in an outer circumferential surface thereof. The engagement member 50 is inserted into a guide cylinder 32a, which is formed on an internal surface of the external cover 32, to be rotated.

The support 35 is coupled to be engaged with the sawtooth of the engagement member 50. Accordingly, the engagement member 50 is rotated according to movement of the support 35.

The support 35 is configured to stably hold a portable terminal during charging of the portable terminal.

A portion of the support 35 is inserted between the external cover 32 and the internal cover 33 to be coupled to the cover 31. Accordingly, when the support 35 is disposed on one side of the cover 31 and the cover 31 is closed, the support 35 is disposed in the accommodation space 21.

The internal cover 33 includes a coupling groove 33a. The coupling groove 33a is a space in which support 35 is disposed. Support 35 moves in coupling groove 33a. Accordingly, a moving distance of the support 35 may be determined to correspond to the size of a coupling groove 33a.

As shown in FIG. 6, the support 35 includes first, second, and third supports 35a, 35b, and 35c.

The first and second supports 35a and 35b face each other and are coupled to the cover 31. The first and second supports 35a and 35b move. In this case, the first and second supports 35a and 35b move toward each other or apart from each other. That is, the first and second supports 35a and 35b move towards or away from a center of the cover 31.

The third support 35c is disposed between the first and second supports 35a and 35b and may move perpendicularly to the moving direction of the first and second supports 35a and 35b.

For example, the third support 35c is disposed adjacent to a rotation axis P of the cover portion 30 and is coupled to the cover 31. In this configuration, the third support 35c to be moved close to or away from the center of the cover 31.

Referring to FIG. 6, the first to third supports 35a, 35b, and 35c each include the insertion portion 39 configured to be inserted into the cover 31, an extension portion 38 extending outside of the cover 31 from the insertion portion 39, and a protrusion portion 37 extending toward the center of the cover 31 from an end of the extension portion 38.

Thus, a space formed between the cover 31 and the protrusion portion 37 of the first to third supports 35a, 35b, and 35c is a space into which the portable terminal 1 may be inserted.

Accordingly, a distance between the cover 31 and the protrusion portion 37 may be determined according to the length of the extension portion 38. The distance between the cover 31 and the protrusion portion 37 may be determined by a maximum thickness of the portable terminal 1 inserted between the cover 31 and the protrusion portion 37.

The insertion portion 39 longitudinally extends in a plane direction of the cover 31 in the extension portion 38. The insertion portion 39 includes a sawtooth portion configured to engage with the sawtooth of the engagement member 50, and is formed at one side of the insertion portion 39. Accordingly, the engagement member 50 and the insertion portion 39 are coupled to each other in the form of a rack and pinion gear.

The sawtooth of each insertion portion 39 of the first to third supports 35a, 35b, and 35c is disposed to engage with the sawtooth of the engagement member 50. Accordingly, as the engagement member 50 rotates, the first to third supports 35a, 35b, and 35c are simultaneously moved.

For example, when the engagement member 50 rotates in a direction R in FIG. 6, as illustrated in FIG. 4, the first to third supports 35a, 35b, and 35c are moved toward each other such that a portable terminal may be held by the first to third supports 35a, 35b, and 35c.

On the other hand, when the engagement member 50 rotates in a direction L in FIG. 6, as illustrated in FIG. 3, the first to third supports 35a, 35b, and 35c are moved apart from each other such that the first to third supports 35a, 35b, and 35c become separated from the portable terminal, and thus a user may easily remove the portable terminal out of the wireless charging device 100.

When the user moves any one of the first to third supports 35a, 35b, and 35c, the corresponding support rotates the engagement member 50 while being moved, and thus the other supports 35b and 35c engaged with the engagement member 50 is also moved.

Accordingly, even if only one support 35a is moved, the other supports 35b and 35c also move as a result, and thus the portable terminal configured to be disposed in the insertion space 40 may be very easily inserted and removed.

Additionally or alternatively, the first to third supports 35a, 35b, and 35c may be elastically coupled to the cover 31 through an elastic coupler 80.

The elastic coupler 80 may be elastically coupled to the cover 31 and the insertion portion 39 of any one of the first to third supports 35a, 35b, and 35c. Accordingly, when external force is applied to the first to third supports 35a, 35b, and 35c such that the support 35 is separated from the center of the cover 31, the elastic coupler 80 may be lengthened to be elastically deformed. Accordingly, elastic force of moving the center of the cover 31 may be continuously applied to the support 35 to stably support the portable terminal inserted into the insertion space 40.

Any of various members for providing elastic force, such as a spring and a rubber member may be used as the elastic coupler 80. For example, the elastic coupler 80 may be realized by connecting the insertion portion 39 and the external cover 32 through a coil spring.

A case in which the first support 35a and the external cover 32 are connected using one elastic coupler 80 show is shown in FIG. 6. However, the connection method according to the present embodiments in the present disclosure is not limited to the case, and thus various modifications may be made, and for example, the elastic coupler 80 is disposed with respect to all of the supports 35a, 35b, and 35c.

Additionally, or alternatively, the wireless charging device 100 may include a buffer member 70.

The buffer member 70 may be attached to the external cover 32 or an internal surface of the protrusion portion 37, facing the external cover 32, to prevent the portable terminal from sliding and to prevent the portable terminal from being damaged.

Accordingly, the buffer member 70 include a pad, a block, or a band formed of rubber or sponge, but is not limited thereto.

The above-described vehicle wireless charging device may wirelessly charge a battery of a portable terminal while accommodating the portable terminal in a cup holder cover installed in most vehicles to effectively use a space in the vehicle. Thus, the portable terminal may be held firmly so as to reduce shaking, enhancing charging efficiency.

The portable terminal may be easily positioned in a center of the wireless charging module by the support, thereby enhancing charging efficiency.

As set forth above, a battery of the portable terminal may be wirelessly charged while the portable terminal is accommodated in a cover of the accommodation unit to effectively use a space in the vehicle, and the portable terminal may be stably and fixedly held to enhance charging efficiency. The portable terminal may be easily positioned in a center of the wireless charging module by the support, thereby enhancing charging efficiency.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A wireless charging device, comprising:
a cover rotatably coupled to an interior member of the vehicle and including a wireless charging module formed therein; and
a support disposed on one side of the cover and configured to support a power receiving device to receive power transmitted from the wireless charging module,
wherein the support is coupled to the cover and is configured to adjust to dimensions of the power receiving device.

2. The wireless charging device of claim 1, wherein the support comprises:
first and second supports spaced apart and facing each other; and
a third support configured to move perpendicularly to a moving direction of the first and second supports.

3. The wireless charging device of claim 1, wherein:
the cover comprises an external cover, and an internal cover coupled to one surface of the external cover; and
the support is disposed at least partially between the external cover and the internal cover.

4. The wireless charging device of claim 3, wherein the support comprises:
an insertion portion disposed between the external cover and the internal cover;
an extension portion extending away from the insertion portion; and
a protrusion portion protruding from the extension portion toward a center of the cover.

5. The wireless charging device of claim 4, further comprising a rotating engagement member disposed between the external cover and the internal cover, the rotating engagement member comprising a first sawtooth portion disposed on an outer circumferential surface of the engagement member.

6. The wireless charging device of claim 5, wherein the insertion portion comprises a second sawtooth portion configured to engage with the first sawtooth portion.

7. The wireless charging device of claim 5, wherein the insertion portion and the engagement member are coupled to each other to form a rack & pinion gear.

8. The wireless charging device of claim 4, further comprising an elastic coupler having a first end coupled to the insertion portion and a second end coupled to one surface of the external cover to elastically couple the insertion portion and the external cover.

9. The wireless charging device of claim 8, wherein the elastic coupler comprises a coil spring.

10. The wireless charging device of claim 4, wherein the protrusion portion comprises a buffer member disposed on an internal surface of the protrusion portion, facing the cover.

11. The wireless charging device of claim 1, wherein the wireless charging module comprises:
a coil portion comprising a coil; and
a circuit portion electrically connected to the coil portion and configured to control power supplied to the coil portion.

12. The wireless charging device of claim 11, wherein the coil portion and the circuit are each plate-shaped and disposed on the external cover overlapping each other.

13. The wireless charging device of claim 1, wherein the support comprises a plurality of supports that are each spaced apart from each other and configured to each move toward a center of one surface of the cover.

14. The wireless charging device of claim 1, wherein the support is configured to hold a center axis of the power receiving device against a center axis of the wireless charging module.

15. A wireless charging device, comprising:
a cover configured to open and close an opening of an accommodation space;
a support configured to accommodate a power receiving device disposed on one side of the cover; and
a wireless charging module configured to wirelessly transmit power to the power receiving device disposed in the cover.

16. The wireless charging device of claim 14, wherein the wireless charging module comprises:
a coil portion comprising a coil; and
a circuit portion electrically connected to the coil portion and configured to control power supplied to the coil portion.

17. A wireless charging device, comprising:
a support disposed on one side of a cover and configured to support a power receiving device to receive power transmitted from a wireless charging module,
wherein the support is coupled to the cover and is configured to adjust to dimensions of the power receiving device.
